(19) United States
(12) Patent Application Publication
(10) Pub. No.: US 2024/0394611 A1
(43) Pub. Date: Nov. 28, 2024

(54) INFORMATION PROCESSING APPARATUS AND RESERVATION MANAGEMENT SYSTEM

(71) Applicant: KYOCERA Document Solutions Inc., Osaka (JP)

(72) Inventors: Junpei TAKADA, Osaka (JP); Fumiya SAKASHITA, Osaka (JP); Shoichi SAKAGUCHI, Osaka (JP); Yumi HIROBE, Osaka (JP); Takuma FUJIKAWA, Osaka (JP)

(73) Assignee: KYOCERA Document Solutions Inc., Osaka (JP)

(21) Appl. No.: 18/693,616

(22) PCT Filed: Aug. 1, 2023
(86) PCT No.: PCT/JP2023/028134

§ 371 Date: Mar. 20, 2024

(30) Foreign Application Priority Data
Aug. 10, 2022 (JP) 2022-128453

(51) Int. Cl. G06Q 10/02

(52) U.S. Cl. CPC G06Q 10/02

(57) ABSTRACT

In a reservation management system, a controller of an information processing apparatus of a meeting room writes that an occupied meeting room has become vacant in a timetable, and causes a display device to display the timetable, when a communication device receives information that a manager of the meeting has logged out from the information processing apparatus, and a predetermined time has elapsed after the time of the log-out, in a state where exit from the occupied meeting room has not been inputted to the operation device.

### TECHNICAL FIELD

The present invention relates to an information processing apparatus and a reservation management system, and in particular to a technique to promote improvement in utilization efficiency of a meeting room.

### BACKGROUND ART

A reservation management system is known that includes a plurality of information processing apparatuses, sharing among them through a server on a network, a timetable showing whether a meeting room is occupied or waiting for entry, and reservation status of the meeting room.

For example, a resource reservation system according to Patent Literature (PTL) 1 includes a meeting management server that contains information about reservation for a resource such as a meeting room, and a terminal device of the meeting room. The meeting management server recognizes the start and finish of the meeting, on the basis of a check-in operation and a check-out operation performed through the terminal device of the meeting room. The terminal device displays a time remaining before the reservation for the meeting room is automatically cancelled, in the case where the check-in operation to the meeting room has not been performed, on the basis of the information received from the meeting management server. Such an arrangement facilitates the user to determine whether to wait for the cancellation of the meeting room.

In addition, a sharing support system according to PTL 2 includes a sharing support server that manages reservation information for a shared facility, and a communication terminal of the meeting room. The sharing support server starts to perform various operations, according to a sign-in operation performed through the communication terminal of the meeting room. The sharing support server calculates, before a scheduled use finish time of the shared facility shared by a plurality of users, a first time between the current time and a next scheduled use start time of the shared facility, and transmits, when the first time is equal to or longer than a first predetermined time, information indicating that extension of use of the shared facility is possible, to the communication terminal using the shared facility. Such an arrangement facilitates the extended use of the shared facility.

### CITATION LIST

### Patent Literature

PTL 1: Japanese Unexamined Patent Application Publication No. 2021-81865
PTL 2: Japanese Unexamined Patent Application Publication No. 2019-175442

### SUMMARY OF INVENTION

### Technical Problem

With the technique according to PTL 1, the start and the finish of the meeting are recognized on the basis of the check-in operation and the check-out operation, performed through the terminal device of the meeting room. However, in the event that the user has forgotten and failed to perform the check-out operation of the meeting, the management of the meeting room becomes unable to be properly carried out.

With the technique according to PTL 2, the operations are started according to the sign-in operation performed through the communication terminal of the meeting room. However, PTL 2 makes no specific reference to operation to be performed at the end of the meeting. In addition, there no reference to the case where the user has forgotten and failed to perform the operation for the end of the meeting, and to the measures to be taken in such a case.

The present invention has been accomplished in view of the foregoing situation, and provides a technique to properly manage the meeting room even when the user has forgotten and failed to perform the operation for the end of the meeting, thereby improving utilization efficiency of the meeting room.

### Solution to Problem

In an aspect, the present invention provides an information processing apparatus that shares a timetable containing information indicating at least one of a state of “reserved”, a state of “occupied”, and a state of “vacant”, with respect to an event execution site, and a manager who has made reservation for the event execution site, with another information processing apparatus via a server on a network. The information processing apparatus includes a communication device that transmits and receives data including the timetable, to and from the other information processing apparatus via the server, a storage device for storing the timetable, a display device, an operation device to which an instruction based on user's operation is inputted, and a controller that writes the “reserved” and the manager in the timetable, when the reservation for the event execution site and the manager are inputted to the operation device, writes the “occupied” in the timetable, when entry to the reserved event execution site is inputted to the operation device, and updates the timetable by substituting the “occupied” of the event execution site with the “vacant”, and causes the display device to display the timetable, when the communication device receives information that the manager has logged out from the other information processing apparatus, and a predetermined time has elapsed after a time of the log-out, in a state where exit from the occupied event execution site has not been inputted to the operation device.

In another aspect, the present invention provides a reservation management system including a plurality of information processing apparatuses that share, with one another, a timetable containing information indicating at least one of reservation, an occupied state, and a vacant state with respect to an event execution site, and a manager who has made the reservation for the event execution site, via a server on a network. In the information processing apparatus, at least one of the plurality of information processing apparatuses is the information processing apparatus according to the foregoing aspect.

### Advantageous Effects of Invention

The mentioned arrangement enables proper management of the meeting room, even when the user has forgotten and failed to perform the operation for the end of the meeting, thereby improving utilization efficiency of the meeting room.

### BRIEF DESCRIPTION OF DRAWINGS

FIG. 1 is a block diagram showing a configuration of a reservation management system according to an embodiment of the present invention.

FIG. 2 is a block diagram showing an essential configuration of an information processing apparatus.

FIG. 3 is a schematic drawing showing an example of a timetable of meeting.

FIG. 4A is a flowchart showing a control process for schedule management.

FIG. 4B is a flowchart showing a control process subsequent to FIG. 4A.

FIG. 4C is a flowchart showing another control process subsequent to FIG. 4A.

FIG. 4D is a flowchart showing still another control process subsequent to FIG. 4A.

FIG. 5 is a schematic drawing showing an example of a pop-up window for logging in.

FIG. 6A is a schematic drawing showing an example of an updated timetable of meeting.

FIG. 6B is a schematic drawing showing another example of the updated timetable of meeting.

FIG. 7 is a schematic drawing showing another example of the updated timetable of meeting.

FIG. 8 is a schematic drawing showing another example of the updated timetable of meeting.

FIG. 9 is a schematic drawing showing an example of a pop-up window displaying a cancel request for a meeting room.

FIG. 10 is a schematic drawing showing an example of the updated timetable of meeting.

FIG. 11 is a schematic drawing showing an example of a pop-up window displaying a next reservation request for a meeting room.

FIG. 12 is a schematic drawing showing an example of a pop-up window asking whether extension of use of the meeting room is approved.

FIG. 13 is a schematic drawing showing an example of the updated timetable of meeting.

FIG. 14 is a schematic drawing showing an example of a pop-up window displaying a time remaining before the end time of the meeting.

FIG. 15 is a schematic drawing showing an example of a pop-up window displaying options for updating the reservation.

### DESCRIPTION OF EMBODIMENT

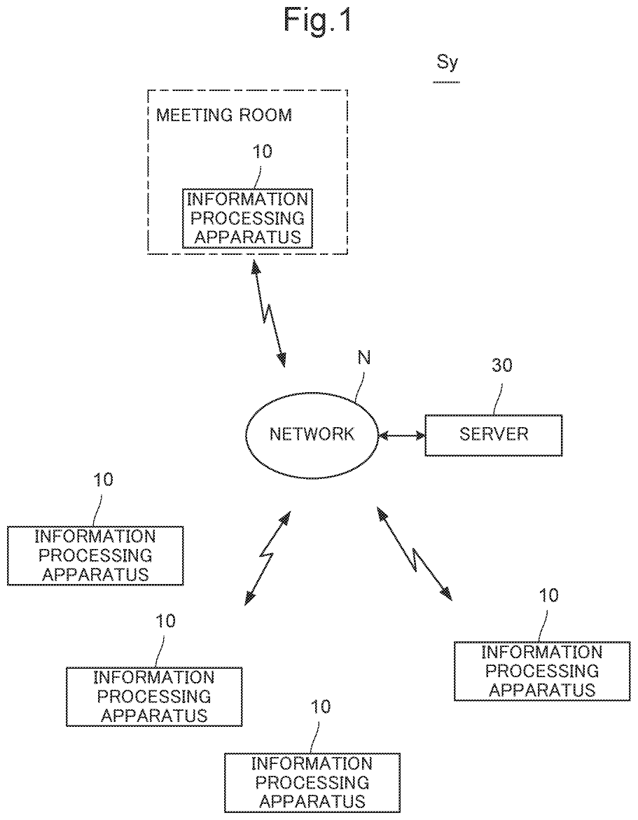

Hereafter, an information processing apparatus and a reservation management system, according to an embodiment of the present invention, will be described with reference to the drawings. FIG. 1 is a block diagram showing a configuration of the reservation management system Sy according to the embodiment of the present invention.

The reservation management system Sy includes a plurality of information processing apparatuses 10. In the reservation management system Sy, the plurality of information processing apparatuses 10 are each connected to a network (e.g., intranet) N, to transmit and receive various types of information to and from each other, via a server 30 on the network N. The information processing apparatuses 10 each make access to the server 30, via the network N. The number of information processing apparatuses 10 is not specifically limited.

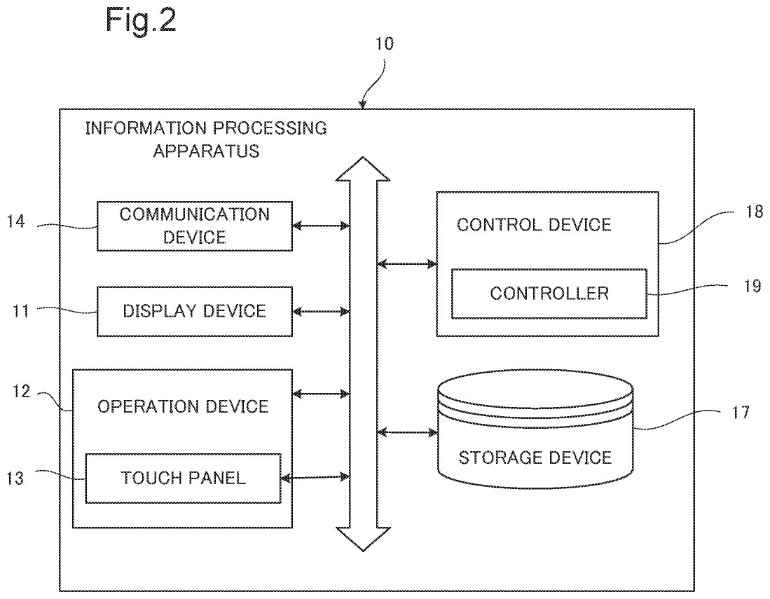

FIG. 2 is a block diagram showing an essential configuration of the information processing apparatus 10. The information processing apparatus 10 may be, for example, a personal computer, a portable smartphone, or a mobile terminal. The information processing apparatus 10 includes a display device 11, an operation device 12, a touch panel 13, a communication device 14, a storage device 17, and a control device 18.

The display device 11 is, for example, constituted of a liquid crystal display (LCD) or an organic light-emitting diode (OLED) display.

A touch panel 13 is overlaid on the screen of the display device 11. The touch panel 13 detects a contact (touch) of the user's finger, along with the touched position, and outputs a detection signal indicating the coordinate of the touched position, to a controller 19 of the control device 18. Therefore, instructions based on a graphical user interface (GUI), displayed on the screen of the display device 11, can be inputted through the touch panel 13. The touch panel 13 acts as a part of the operation device 12.

The operation device 12 includes a keyboard, a pointing device, and physical keys, to be operated by the user. The operation device 12 receives inputs of various instructions, corresponding to the user's operation performed on the keyboard or other devices, and outputs the received instruction to the controller 19.

The communication device 14 is a communication interface having a communication module such as a local area network (LAN) chip. The communication device 14 is connected to the server 30 via the network N, and performs data communication with the server 30.

The storage device 17 is a large-capacity storage device such as a solid-state drive (SSD) or a hard disk drive (HDD). The storage device 17 contains various application programs and various types of data.

The control device 18 includes a processor, a random-access memory (RAM), a read-only memory (ROM), and so forth. The processor is, for example, a central processing unit (CPU), an application specific integrated circuit (ASIC), or a micro processing unit (MPU). The control device 18 acts as the controller 19, when the processor executes an information notification program stored in the ROM or the storage device 17.

The control device 18 is connected to the display device 11, the operation device 12, the touch panel 13, the communication device 14, and the storage device 17.

The controller 19 serves to control the overall operation of the information processing apparatus 10. The controller 19 controls the operation of the components cited above, and transmits and receives signals and data to and from those components.

The controller 19 acts as a processing device that executes various types of operations. The controller 19 has the function to control the display device 11 and the communication device 14.

In the reservation management system Sy configured as above, one of the plurality of information processing apparatuses 10 is, for example, a personal computer (PC) installed in a meeting room (exemplifying the event execution site), or a PC under the control of a user acting as a manager. Such PCs will hereinafter be referred to as the information processing apparatus 10 of the meeting room. The information processing apparatus 10 of the meeting room is operated by the manager of a meeting (exemplifying the event). The remaining information processing apparatuses 10 are, for example, PCs installed on the respective seats of the participants of the meeting, or mobile phones or mobile terminals carried by the respective participants, which are operated by the respective participants (hereinafter referred to as information processing apparatuses 10 of participants).

The manager and the participants correspond to a plurality of users who utilize the reservation management system Sy and the respective information processing apparatuses 10. Here, one of the participants may also act as the manager.

In all of the information processing apparatus 10, when the information notification program is activated, a schedule management operation is performed to improve the utilization efficiency of the meeting room, according to the information notification program.

The server 30 is connected to the network N (e.g., an in-house network). Each of the information processing apparatuses 10 can make access to the server 30.

In the information processing apparatus 10 of the meeting room, for example, when a specific icon displayed on the display device 11 is designated, through the operation of the manager performed on the pointing device or keyboard of the operation device 12, an instruction to activate the information notification program is received by the operation device 12. The controller 19 performs the schedule management operation to be subsequently described, to improve the utilization efficiency of the meeting room, according to the information notification program stored in the storage device 17. The information notification program is an application program for writing, transmitting, and receiving e-mails (e.g., program based on Outlook of Microsoft Office 365 from Microsoft Corporation, but without limitation thereto).

The users (the manager of the meeting and the participants) operate the pointing device or keyboard of the operation device 12, on their respective information processing apparatuses 10, to input a display instruction to display the timetable of meeting, stored in the storage device 17. When the display instruction is inputted to the operation device 12, the controller 19 causes the display device 11 to display the timetable stored in the storage device 17, according to the display instruction. The controller 19 also rewrites and updates the timetable of meeting, according to the instruction inputted to the operation device 12 by the operation of the user. Here, as will be subsequently described, the timetable of meeting is shared among the information processing apparatuses 10 of the respective users.

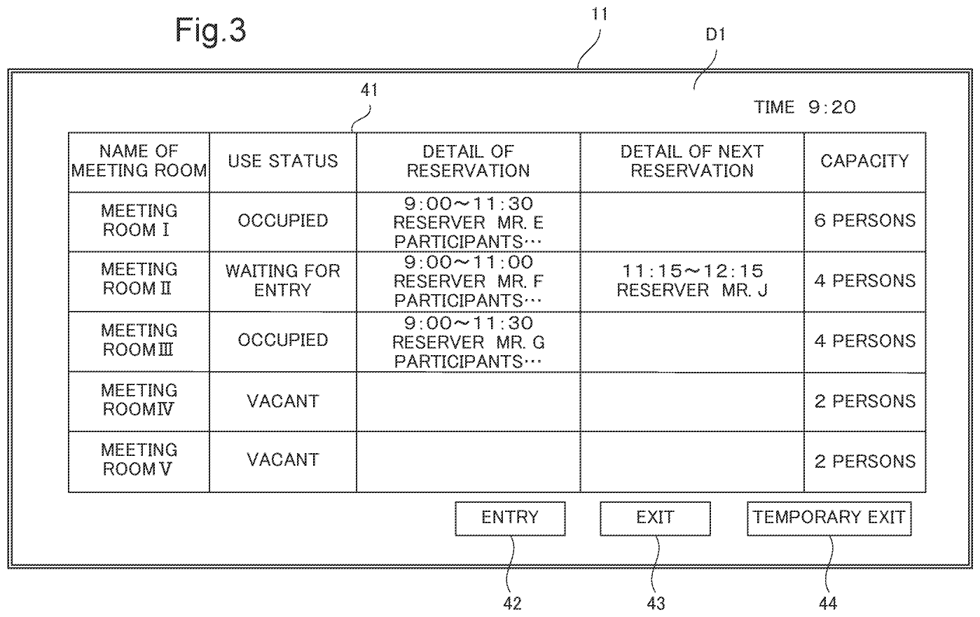

FIG. 3 illustrates an example of the timetable of meeting, displayed on the screen of the display device 11. The timetable of meeting 41 shown in FIG. 3 contains the name of the meeting room (meeting room I, II, III . . . ), the use status of the meeting room (information such as “reserved”, “occupied”, “waiting for entry”, or “vacant”), the detail of reservation (information indicating that the meeting room has been reserved, the reserved time, the reserver, and the participants of the meeting to be held in the meeting room), the detail of next reservation, and the capacity, with respect to each of the plurality of meeting rooms. In the timetable 41, the use status of the meeting room is specified as “occupied”, “waiting for entry”, or “vacant”. The detail of reservation is written by the controller 19 when the reservation for the meeting room has been made, and includes the start and end times of the meeting, the name of the reserver, and the participants. The detail of next reservation is written when the next reservation for the meeting room has been made. The capacity of the meeting room represents the number of persons prespecified with respect to each of the meeting rooms. The manager corresponds to the person who made the reservation of the meeting, and the reserver shown in the timetable of meeting 41 represents the manager.

A reservation display screen DI of the display device 11 includes, in addition to the timetable of meeting 41, an entry key 42, an exit key 43, and a temporary exit key 44.

Upon entering the meeting room, the manager operates the pointing device or keyboard of the operation device 12 of the PC installed in the meeting room, or his/her own PC, in other words the information processing apparatus 10 of the meeting room, to input a log-in request using log-in information including, for example, the ID information of the manager. The controller 19 of the information processing apparatus 10 of the meeting room performs log-in operation according to the log-in request, and also causes the display device 11 to display the reservation display screen DI.

When the entry key 42 is pressed, the controller 19 of the information processing apparatus 10 of the meeting room receives an entry notification through the operation device 12, and changes the use status of the meeting room in the timetable of meeting 41 from “vacant” to “occupied”, according to the entry notification, thus to update the timetable of meeting 41.

Before exiting from the occupied meeting room, the manager presses the exit key 43 by operating the pointing device or keyboard of the operation device 12 of the information processing apparatus 10 of the meeting room, thereby inputting an exit notification. The controller 19 changes the use status of the meeting room in the timetable of meeting 41 from “occupied” to “vacant”, according to the exit notification, thus to update the timetable of meeting 41.

Here, until the use start time, corresponding to the reserved time of the meeting room, is reached, and the entry notification is inputted, the controller 19 specifies the use status of the meeting room in the timetable of meeting 41 as “waiting for entry”.

Now, there may be a case where the manager exits from the meeting room, without inputting the exit notification to the information processing apparatus 10 of the meeting room. In this case, if the use status of the meeting room in the timetable of meeting 41 is kept unchanged from “occupied”, the participant intending to use the meeting room next recognizes that the meeting room is unusable until the use status of the meeting room turns to “vacant”, since the use status of the meeting room continues to be displayed as “occupied”, each time the timetable of meeting 41 is checked.

In this embodiment, therefore, the controller 19 of the information processing apparatus 10 of the meeting room changes the use status of the meeting room in the timetable of meeting 41 from “occupied” to “vacant”, despite the exit notification not having been inputted, when the communication device 14 receives the information that the participant (e.g., manager) of the meeting being held in the meeting room has logged out from the information processing apparatus 10, and a predetermined time (e.g., 10 min.) has elapsed after the log-out time (e.g., the time that the log-out information, to be subsequently described, is received, or the time of log-out). Accordingly, it can be perceived that the meeting room is usable, in view of the timetable of meeting 41, even though the manager has forgotten and failed to input the exit notification. Thus, the utilization efficiency of the meeting room can be improved. Here, the log-out information includes the ID information of the person who has logged out, and the information indicating that this person has logged out.

The controller 19 of the information processing apparatus 10 of the meeting room is also configured to perform various types of operations according to the use status of the meeting room in the timetable of meeting 41, for example according to a reservation cancel request for the meeting room from another user, or a request from the manager to extend the use of the meeting room. Such arrangements also contribute to improving the utilization efficiency of the meeting room.

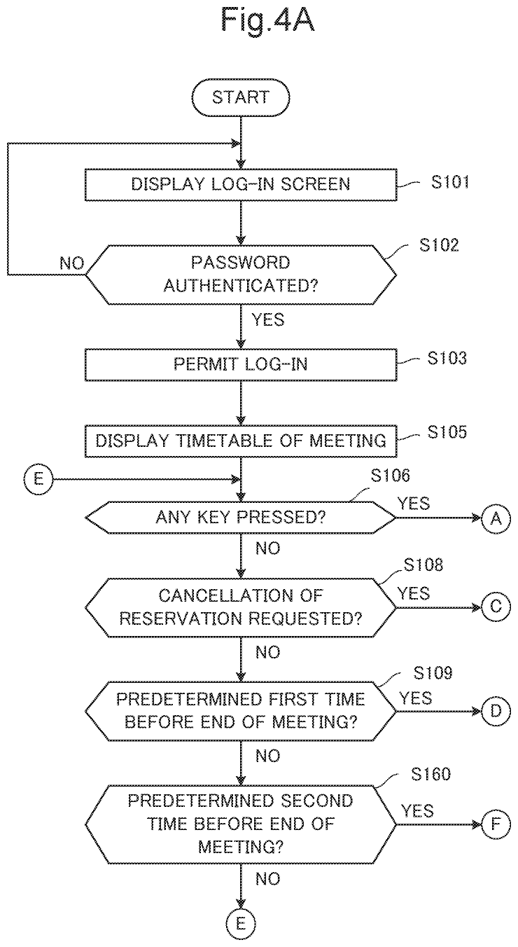

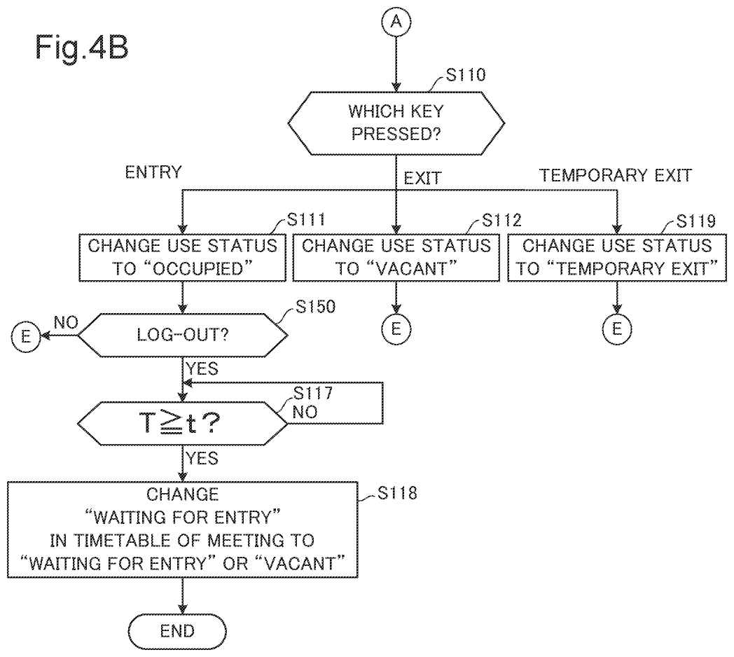

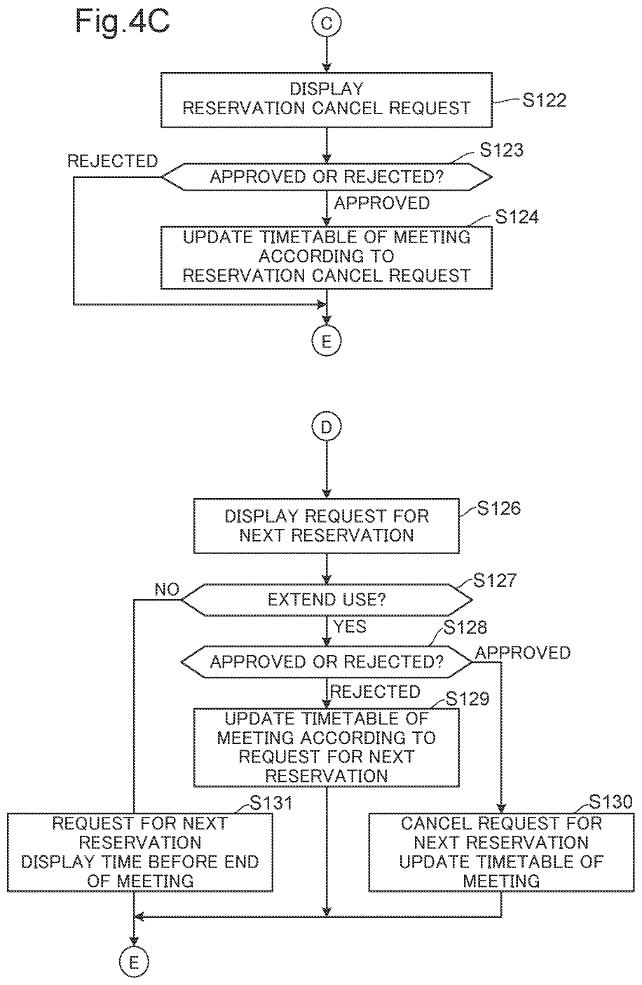

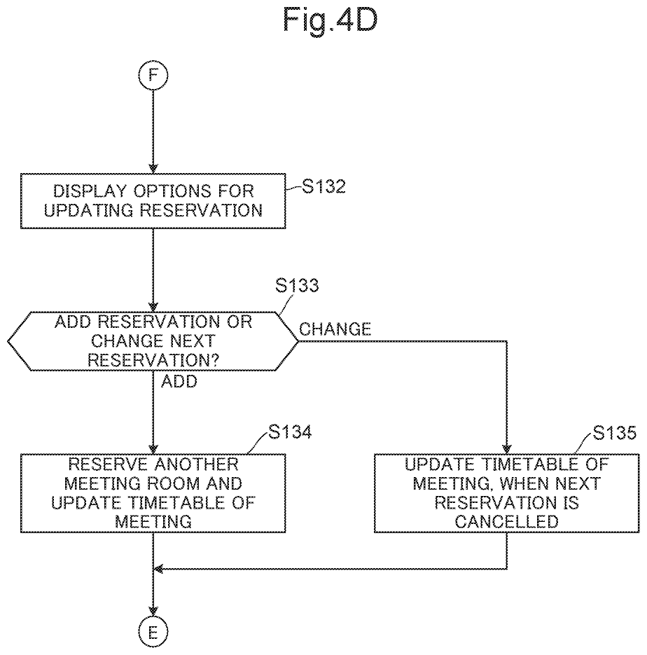

Referring now to flowcharts shown in FIG. 4A, FIG. 4B, FIG. 4C, and FIG. 4D, the control process for the schedule management operation, for improving the utilization efficiency of the meeting room utilizing the timetable of meeting 41 as above, will be described in detail hereunder.

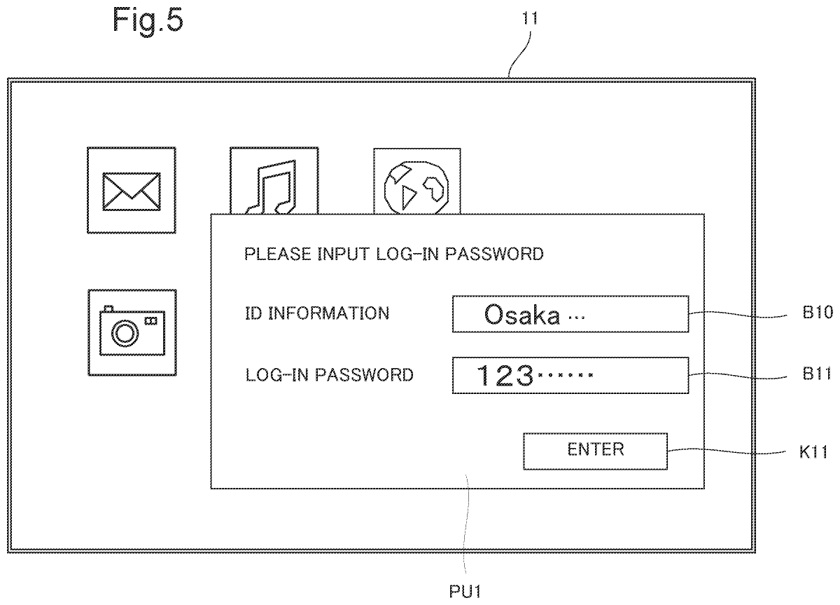

In the information processing apparatus 10 of the meeting room, when a specific icon displayed on the display device 11 is designated, through the operation of the manager performed on the pointing device or keyboard of the operation device 12, an instruction to activate the information notification program is received by the operation device 12. The controller 19 causes the display device 11 to display a pop-up window PU1 for logging in shown in FIG. 5, according to the instruction (step S101). The pop-up window PU1 for logging in includes a text box B10 for filling in the ID information of the manager, a text box B11 for filling in the log-in password of the manager, and an execution key K11.

The manager inputs the ID information and the log-in password of the manager, by operating the pointing device or keyboard of the operation device 12. The controller 19 of the information processing apparatus 10 of the meeting room displays the inputted ID information in the text box B10 of the pop-up window PU1, and displays the inputted log-in password in the text box B11. When the manager further presses the execution key K11, the controller 19 decides whether the ID information and the log-in password that have been inputted accord with legitimate ID information and log-in password, stored in advance in the storage device 17 (step S102). Upon confirming the accordance (Yes at step S102), the controller 19 permits the log-in (step S103), and executes the information notification program stored in the storage device 17.

Upon deciding that the ID information and the log-in password that have been inputted discord with the legitimate ID information and log-in password, stored in advance in the storage device 17 (No at step S102), the controller 19 of the information processing apparatus 10 of the meeting room does not execute the information notification program instructed through the operation device 12.

The manager instructs to display the timetable of meeting 41, by operating the pointing device or keyboard of the operation device 12. In response to this instruction, the controller 19 of the information processing apparatus 10 of the meeting room causes the display device 11 to display the timetable of meeting 41 stored in the storage device 17, on the screen (step S105). In other words, the controller 19 of the information processing apparatus 10 of the meeting room causes the display device 11 to display, in response to the instruction, the reservation display screen DI shown in FIG. 3, on the screen of the display device 11 (step S105).

Here, it will be assumed that the information processing apparatus 10 of the meeting room is installed in the meeting room II. In this case, the information processing apparatus 10 of the meeting room is keeping the identification information of the meeting room II, for example in a non-volatile memory. The controller 19 sets, on the basis of the identification information of the meeting room II, the use status, the detail of reservation, the detail of next reservation, and the capacity of the meeting room II in the timetable of meeting 41, as objects of management by the information processing apparatus 10 of the meeting room. The timetable of meeting 41 displayed on the reservation display screen DI shown in FIG. 3 represents an example in which the use status of the meeting room II is “waiting for entry”, the detail of reservation is specified such that the start time of the meeting is 9:00 and the end time is 11:00, and the name of the reserver is Mr. F, the detail of next reservation is specified such that the start time of the meeting is 11:15 and the end time is 12:15, and the name of the reserver is Mr. J, and the capacity is four persons.

The timetable of meeting 41 displayed on the reservation display screen DI is stored in the storage device 17. In each of the plurality of information processing apparatuses 10, the controller 19 executes the information sharing function according to the information notification program. Among the information processing apparatuses 10, each including the information processing apparatus 10 of the meeting room, the timetable of meeting is shared via the network N and the server 30, by means of the information sharing function. To be more specific, the timetable of meeting stored in another information processing apparatus 10 can be received via the own communication device 14, and stored in the storage device 17 in an updated state each time. In other words, the timetable of meeting is synchronized among the information processing apparatuses 10 by means of the information sharing function, and the identical timetable of meeting is stored in each of the information processing apparatuses 10, after the synchronization. Here, the information on the timetable of meeting is written or overwritten by the controller 19, according to the information inputted through the operation device 12 of the information processing apparatus 10. The information sharing function corresponds to a file sharing function, for example when a program based on Outlook of Microsoft Office 365 from Microsoft Corporation is employed as the information notification program.

The controller 19 of the information processing apparatus 10 of the meeting room stands by for an input of one of the entry notification, the exit notification, and the temporary exit notification (No at step S106), stands by for an input of a reservation cancel request for the meeting room II (No at step S108), and stands by for the current time to reach the time a predetermined first time earlier (e.g., 12 min. earlier) than the end time of the meeting in the meeting room II (No at step S109). During such stand-by phase, the controller 19 repeats the operation of step S106 to step S109.

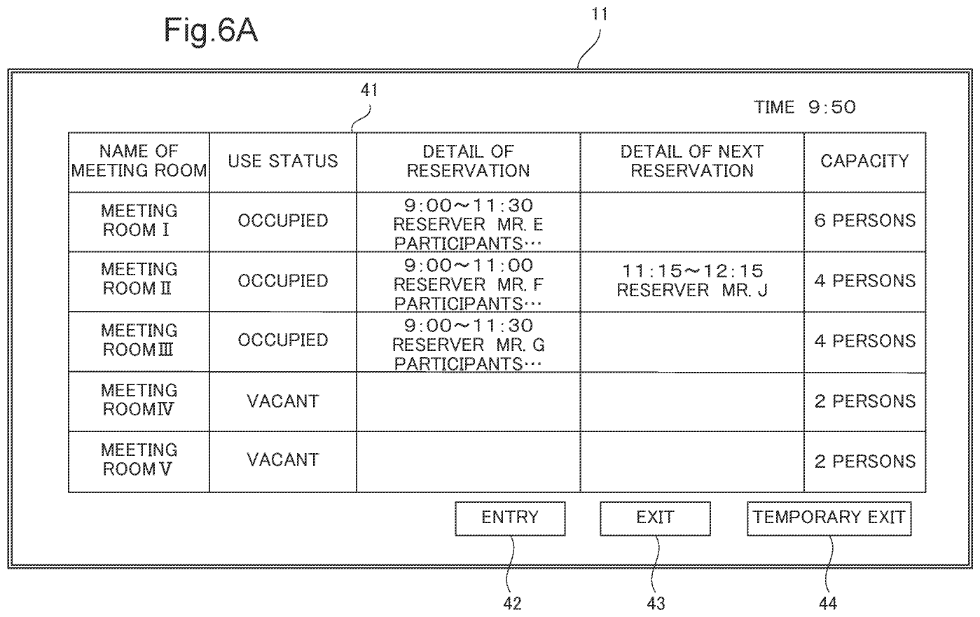

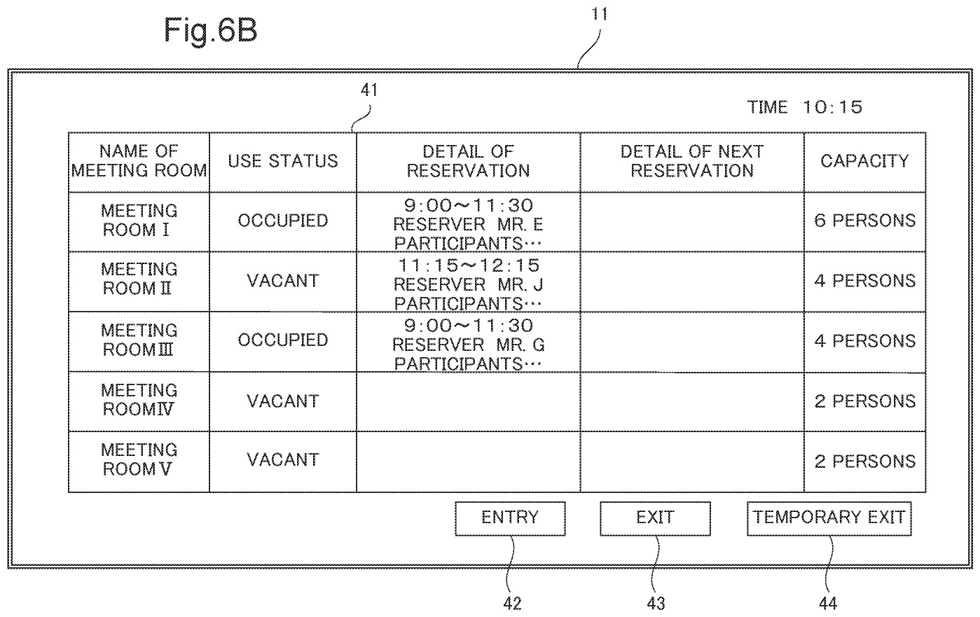

For example, when the manager presses the entry key 42 displayed on the screen of the display device 11, by operating the pointing device or keyboard of the operation device 12, the controller 19 of the information processing apparatus 10 of the meeting room receives the entry notification, via the operation device 12 (Yes at step S106). Then the controller 19 identifies the type of the notification (step S110). Upon deciding that the notification is the entry notification (“Entry” at step S110), the controller 19 updates the use status of the meeting room II in the timetable of meeting 41 displayed on the reservation display screen DI, by changing from “waiting for entry.” to “occupied”, as shown in FIG. 6A (step S111). Thereafter, the controller 19 returns to the operation of step S106 to step S109. The timetable of meeting 41 updated as above is shared among the information processing apparatuses 10, by means of synchronization.

The controller 19 of the information processing apparatus 10 of the meeting room decides, after step S111, whether the communication device 14 has received log-out information indicating that the manager of the meeting in the meeting room has logged out from the information processing apparatus 10 (e.g., information indicating that the manager has logged out, and the time of log-out), without the exit notification from the meeting room II having been inputted (step S150). Upon deciding that the communication device 14 has not received the log-out information of the manager (No at step S150), the controller 19 returns to step S106.

Upon deciding, in contrast, that the communication device 14 has received the log-out information of the manager (Yes at step S150), the controller 19 decides whether an elapsed time T from the time that the log-out information was received, or the time of the log-out, has reached a prespecified time t (e.g., 10 min.), for example with a time-keeping operation by a timer incorporated in the control device 18 (step S117). Upon deciding that the elapsed time T has reached the prespecified time t (Yes at step S117), the controller 19 updates the timetable of meeting 41, as shown in FIG. 6B, by changing the use status of the meeting room II in the timetable of meeting 41 displayed on the reservation display screen DI, from “occupied” to “vacant”, and also changing the content of the detail of reservation to the content of the detail of next reservation (step S118). Thereafter, the controller 19 finishes the schedule management operation. The timetable of meeting 41 updated as above is shared among the information processing apparatuses 10, by means of synchronization.

Here, although the controller 19 is configured, according to this embodiment, to perform the operation of step S117 and step S118, upon deciding that the communication device 14 has received the log-out information of the manager of the meeting in the meeting room, with respect to the information processing apparatus 10 (Yes at step S150), the present invention is not limited to such embodiment. Instead, the controller 19 may perform the operation of step S117 and step S118, upon deciding that the communication device 14 has received the log-out information, with respect to one of the information processing apparatus 10 of a first participant (manager), the information processing apparatus 10 of a second participant (participant other than the manager), and the information processing apparatus 10 installed in the meeting room (Yes at step S150).

When the meeting in the meeting room II is finished, the manager presses the exit key 43 displayed on the screen of the display device 11, by operating the pointing device or key board of the operation device 12, thereby inputting the exit notification. Upon deciding that the inputted notification is the exit notification (Yes at step S106, “Exit” at step S110), the controller 19 of the information processing apparatus 10 of the meeting room updates the timetable of meeting 41, as shown in FIG. 6B, by changing the use status of the meeting room II in the timetable of meeting 41 displayed on the reservation display screen DI, from “occupied” to “vacant”, and also changing the content of the detail of reservation to the content of the detail of next reservation (step S112). Thereafter, the controller 19 returns to the operation of step S106 to step S109. The timetable of meeting 41 updated as above is shared among the information processing apparatuses 10, by means of synchronization.

With the arrangement described above, the timetable of meeting 41 exhibits the content indicating that the meeting room is available, so that other users can recognize such situation, despite the manager having forgotten and failed to input the exit notification. Therefore, the utilization efficiency of the meeting room can be improved.

For example, when the manager presses the temporary exit key 44 displayed on the screen of the display device 11, by operating the pointing device or key board of the operation device 12, the controller 19 of the information processing apparatus 10 of the meeting room decides that the temporary exit notification has been received, via the operation device 12 (Yes at step S106, “temporary exit” at step S110). Here, the “temporary exit” refers to the situation where the use of the meeting room II remains effective, even though the manager or the participant of the meeting has left the meeting room II.

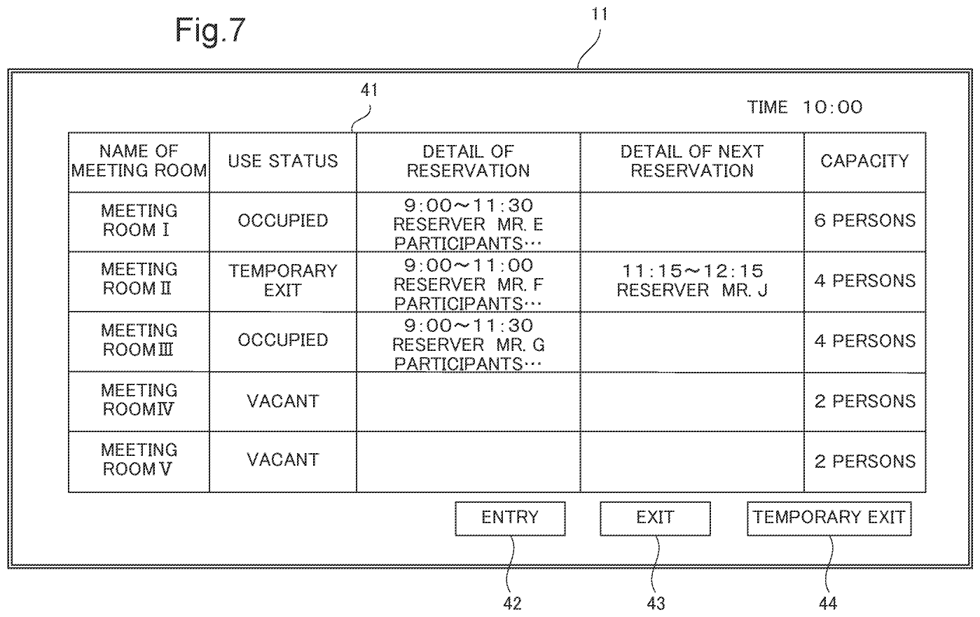

In this case, the controller 19 updates the timetable of meeting 41, as shown in FIG. 7, by changing the use status of the meeting room II in the timetable of meeting 41 from “occupied” to “temporary exit” (step S119). However, the controller 19 regards the status of the meeting room II as remaining occupied. The controller 19 does not change the use status of the meeting room II in the timetable of meeting 41 from “occupied” to “vacant”, despite deciding that, for example, the communication device 14 has received, from one of the information processing apparatuses 10 of the participants, the log-out information indicating that the participant has logged out from the corresponding information processing apparatus 10 of the participant, and that the elapsed time T from the time that the log-out information was received or the log-out time has reached the prespecified time t. Thereafter, the controller 19 returns to the operation of step S106 to step S109. The timetable of meeting 41 updated as above is shared among the information processing apparatuses 10, by means of synchronization.

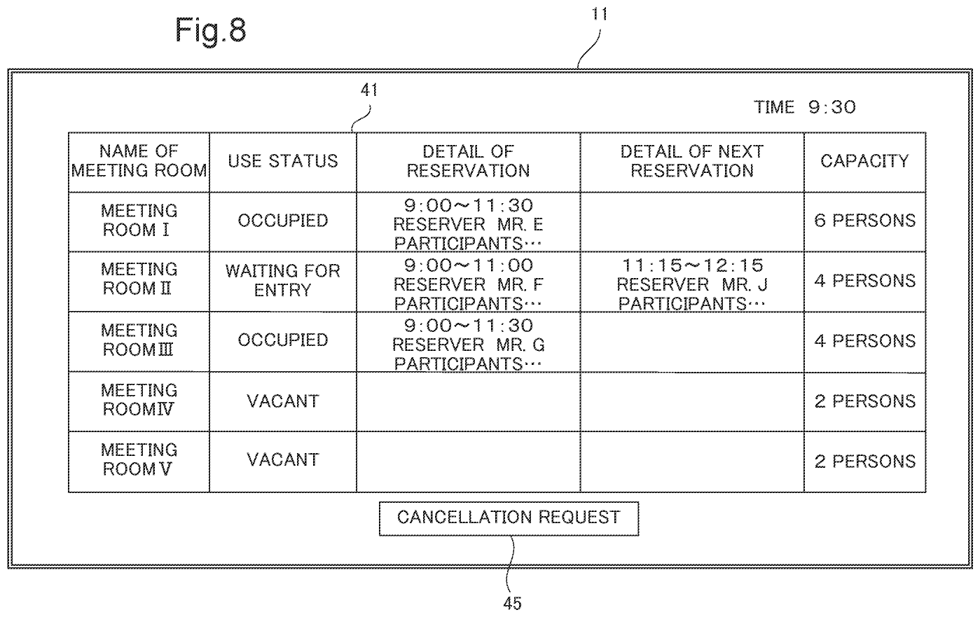

Here, the controller 19 specifies the use status of the meeting room, with respect to which the entry notification has not been inputted, despite the use start time having been reached, as “waiting for entry”, in the timetable 41 (see FIG. 8).

In another information processing apparatus 10, the controller 19 causes the display device 11 to display the timetable of meeting 41 on the screen, in response to a display instruction inputted through the operation of the pointing device or keyboard of the operation device 12.

At this point, for example the timetable of meeting 41 and a cancel request key 45 are displayed on the display device 11 of the other information processing apparatus 10, as shown in FIG. 8. Since the meeting room II is specified as “waiting for entry”, the user of the other information processing apparatus 10 inputs a reservation cancel request for the meeting room II, by designating the meeting room II in the timetable of meeting 41 and then pressing the cancel request key 45, through the pointing device or key board of the operation device 12. The controller 19 of the other information processing apparatus 10 receives the reservation cancel request for the designated meeting room II, and transmits the reservation cancel request for the meeting room II to the information processing apparatus 10 of the meeting room, from the communication device 14 via the network N and the server 30, according to the reservation cancel request received.

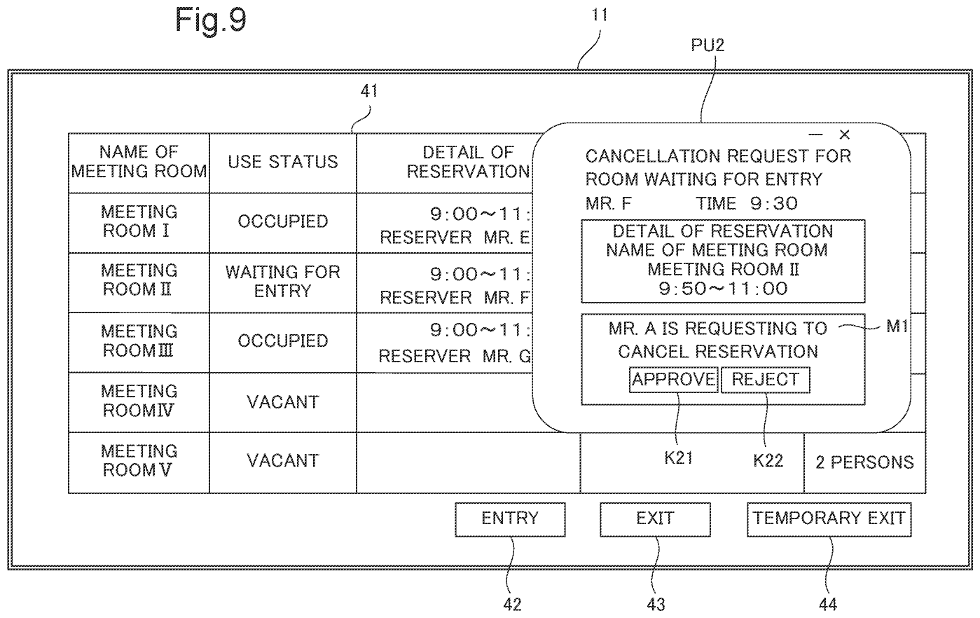

In the case where the information processing apparatus 10 of the meeting room receives, when the meeting room is specified as “waiting for entry” in the timetable 41, the reservation cancel request for the meeting room specified as “waiting for entry” from the other information processing apparatus 10 of the other user as described above, through the communication device 14 via the network N (Yes at step S108), the controller 19 causes the display device to display a message asking whether the reservation cancel request is to be approved or rejected (step S122). For example, the controller 19 causes the display device 11 to display a pop-up window PU2 representing the reservation cancel request for the meeting room II specified as “waiting for entry”, as shown in FIG. 9. The pop-up window PU2 includes the name of the user of the other information processing apparatus 10, the detail of reservation for the meeting room II instructed by the user, a message MI to the effect that the reservation cancel request for the meeting room II specified as “waiting for entry” has been received from the other information processing apparatus 10, an approval key K21, and a rejection key K22.

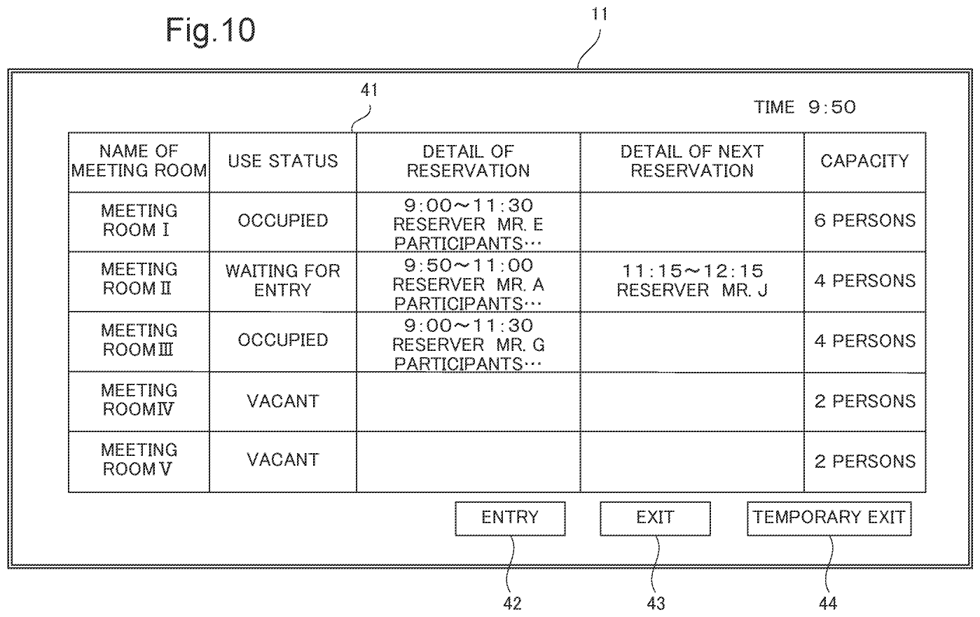

When the instruction to approve the reservation cancel request is inputted to the operation device 12, by a press of the approval key K21 (“Approved” at step S123), the controller 19 cancels the reservation for the meeting room specified as “waiting for entry” in the timetable 41 according to the instruction, and writes the reservation for the meeting room made by the other information processing apparatus 10 of the other user, which made the reservation cancel request, as shown in FIG. 10, thereby updating the timetable 41 (step S124). Thereafter, the controller 19 returns to the operation of step S106 to step S109. The timetable of meeting 41 updated as above is shared among the information processing apparatuses 10, by means of synchronization.

As described above, when the manager forgets to input the entry notification, or refrains from inputting the entry notification because the meeting is unable to be started, the use status of the meeting room II becomes “waiting for entry”, in the timetable of meeting 41. In such a case, the user of the other information processing apparatus 10 can make the reservation cancel request for the meeting room II specified as “waiting for entry”.

In contrast, when the manager presses the rejection key K22, in view of the reservation cancel request for the meeting room II specified as “waiting for entry”, displayed on the pop-up window PU2 shown in FIG. 9, a rejection instruction is inputted to the operation device 12. Upon receipt of the rejection instruction (“Rejected” at step S123), the controller 19 keeps the use status of the meeting room unchanged, without cancelling the reservation for the meeting room specified as “waiting for entry” in the timetable 41. Thereafter, the controller 19 returns to the operation of step S106 to step S109.

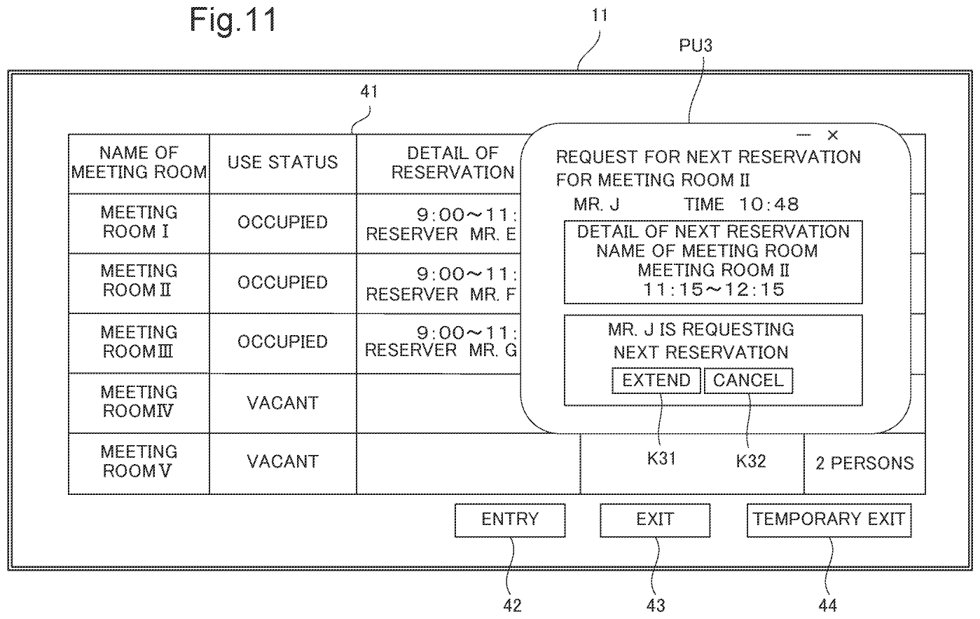

For example, when the time the predetermined first time earlier (e.g., 12 min. earlier) than the end time of the meeting is reached (Yes at step S109), and when the meeting room II is “occupied” and the next reservation for the meeting room II by another user is displayed in the timetable 41, the controller 19 of the information processing apparatus 10 of the meeting room causes the display device 11 to display a message asking whether to request extension of the use of the meeting room II (step S126). The controller 19 causes the display device 11 to display, for example, a pop-up window PU3 representing a request for the next reservation for the meeting room II, as shown in FIG. 11. The pop-up window PU3 includes the name of the user of the other information processing apparatus 10, the detail of the next reservation for the meeting room II instructed by the user, an extension key K31 for requesting the extension of use of the meeting room II, and a cancel key K32 used to keep from requesting the extension of use.

When the manager presses the extension key K31 by operating the pointing device or keyboard of the operation device 12, in view of the request of the next reservation for the meeting room II in the pop-up window PU3, an extension instruction is inputted to the operation device 12. Accordingly, the controller 19 of the information processing apparatus 10 of the meeting room receives the extension instruction (Yes at step S127), and transmits, according to the extension instruction, a request to respond whether to approve the extension of use of the meeting room II, to the information processing apparatus 10 of the other user, from the communication device 14 via the network N and the server 30.

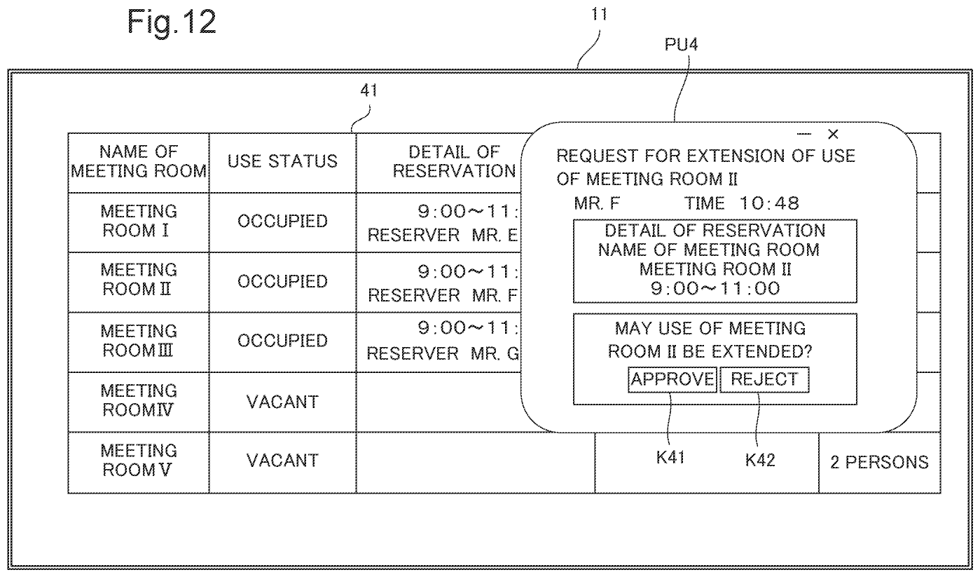

The controller 19 of the other information processing apparatus 10 causes the display device 11 to display, when the request for response is received by the communication device 14, a message requesting to respond whether to approve the extension of use of the meeting room II. For example, the controller 19 causes the display device 11 to display a pop-up window PU4, asking whether the extension of use of the meeting room II may be approved, as shown in FIG. 12. The pop-up window PU4 includes the name of the manager of the information processing apparatus 10 of the meeting room, the detail of the reservation for the meeting room II instructed by the manager, an approval key K41 for approving the request for extension of use of the meeting room II, and a rejection key K42 for rejecting the request for extension of use.

The other user of the other information processing apparatus 10 presses the approval key K41 or the rejection key K42, by operating the pointing device or keyboard of the operation device 12, in view of the request to respond whether to approve the extension of use of the meeting room II in the pop-up window PU4. When the instruction to approve is inputted by a press of the approval key K41, the controller 19 of the other information processing apparatus 10 transmits approval information indicating that the extension of use has been approved, to the information processing apparatus 10 of the meeting room, from the communication device 14 via the network N and the server 30. On the other hand, when a rejection instruction is inputted through the rejection key K42, the controller 19 of the other information processing apparatus 10 transmits rejection information indicating that the extension of use has been rejected, to the information processing apparatus 10 of the meeting room, from the communication device 14 via the network N and the server 30.

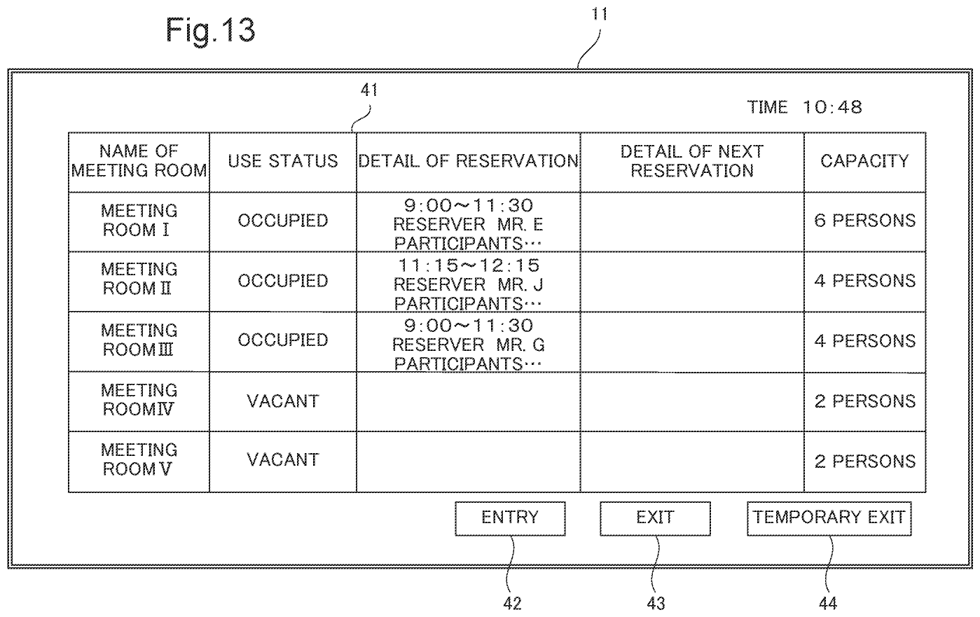

Upon receipt of the approval information or the rejection information through the communication device 14, the controller 19 of the information processing apparatus 10 of the meeting room decides which of the approval information and the rejection information has been received (step S128). For example, upon deciding that the rejection information has been received (“Rejected” at step S128), in other that the extension of use of the meeting room II has been rejected, the controller 19 updates the timetable of meeting 41, as shown in FIG. 13, by substituting the detail of reservation for the meeting room II in the timetable of meeting 41 displayed on the screen of the display device 11, with the content indicating the detail of the next reservation for the meeting room II (step S129). Thereafter, the controller 19 returns to the operation of step S106 to step S109. The timetable of meeting 41 updated as above is shared among the information processing apparatuses 10, by means of synchronization.

In this case, the request for the extension made by the manager is not accepted by the other user, and the detail of the next reservation for the meeting room II in the timetable of meeting 41 is given the priority.

In contrast, upon deciding that the approval information has been received (“Approved” at step S128), in other words that the extension of use of the meeting room II has been approved, the controller 19 of the information processing apparatus 10 of the meeting room updates the timetable of meeting 41, by deleting the detail of the next reservation for the meeting room II in the timetable of meeting 41 (step S130). Thereafter, the controller 19 returns to the operation of step S106 to step S109. The timetable of meeting 41 updated as above is shared among the information processing apparatuses 10, by means of synchronization.

In this case, the request for the extension made by the manager is accepted by the other user, and the next reservation made by the other user is cancelled.

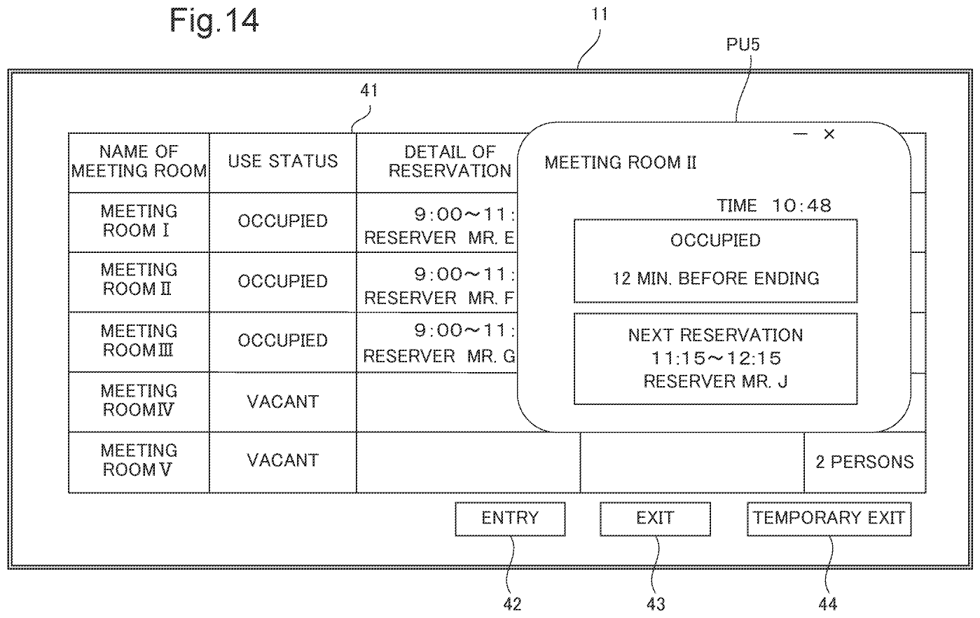

In contrast, when the manager presses the cancel key K32 by operating the pointing device or key board of the operation device 12, in view of the request of the next reservation for the meeting room II in the pop-up window PU3, the controller 19 of the information processing apparatus 10 of the meeting room receives a cancel instruction (No at step S127), and causes the display device 11 to display a pop-up window PU5 shown in FIG. 14, on the screen (step S131). The pop-up window PU5 includes the time remaining before the end time of the meeting conducted by the manager in the meeting room II, the detail of the next reservation for the meeting room II inputted by the other user of the other information processing apparatus 10, and the name of the other user.

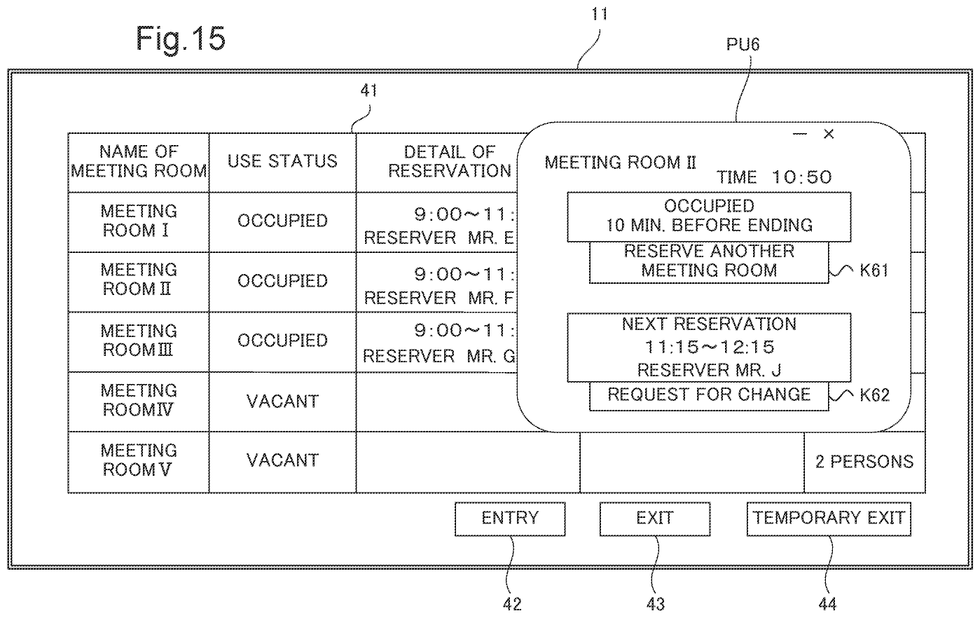

Further, in the case of “No” at step S108, the controller 19 of the information processing apparatus 10 of the meeting room causes display device 11 to display a pop-up window PU6 representing options for updating the reservation, as shown in FIG. 15 (step S132), upon deciding that the current time has reached the time a predetermined second time earlier (e.g., 10 min. earlier, the second time being shorter than the first time) than the end time of the meeting in the meeting room II (Yes at step S160). The pop-up window PU6 representing the options for updating the reservation includes the time remaining before the end time of the meeting in the meeting room II, an additional reservation key K61 for making reservation for another meeting room, the detail of the next reservation for the meeting room II, the name of the reserver, and a change request key K62 for requesting to change the reservation.

When the manager presses the additional reservation key K61 by operating the pointing device or keyboard of the operation device 12, in view of the pop-up window PU6 representing the options for updating the reservation, displayed on the screen of the display device 11, an additional reservation instruction is inputted to the operation device 12. Accordingly, the controller 19 of the information processing apparatus 10 of the meeting room receives the additional reservation instruction (“Add” at step S133), and looks up the timetable of meeting 41 stored in the storage device 17, to thereby detect, from the timetable of meeting 41, another meeting room that is vacant after the end time of the meeting in the meeting room, and has a capacity equal to or larger than the meeting room II. Then the controller 19 displays a message indicating the other meeting room that has been detected from the timetable of meeting 41, in a predetermined region in the reservation display screen DI. The manager recognizes that the other meeting room can be reserved, in view of the timetable of meeting 41, and inputs the reservation information with respect to the other meeting room, by operating the pointing device or keyboard of the operation device 12. The controller 19 further updates the timetable of meeting 41, according to such reservation information (step S134). Thereafter, the controller 19 returns to the operation of step S106 to step S109. The timetable of meeting 41 updated as above is shared among the information processing apparatuses 10, by means of synchronization.

With the mentioned arrangement, the participants of the meeting in the meeting room II can move to the other meeting room, and continue with the meeting.

When the manager presses the change request key K62 by operating the pointing device or keyboard of the operation device 12, a request to change is inputted to the operation device 12. Accordingly, the controller 19 of the information processing apparatus 10 of the meeting room receives the request to change (“Change” at step S133), and looks up the timetable of meeting 41 stored in the storage device 17, to thereby detect, from the timetable of meeting 41, another meeting room that is vacant after the end time of the meeting in the meeting room, and has a capacity equal to or larger than the meeting room II. Then the controller 19 transmits a message indicating the other meeting room detected from the timetable of meeting 41, and a message requesting to change the reservation to the reservation for the other meeting room, to the other information processing apparatus 10 of the other user who made the next reservation for the meeting room II, from the communication device 14 via the network N and the server 30.

The controller 19 of the other information processing apparatus 10 causes the display device 11 to display, when the communication device 14 receives the mentioned messages, the other meeting room indicated by the message, and the request to change the reservation to the reservation for the other meeting room.

In view of the request to change the reservation displayed on the screen of the display device 11, the user of the other information processing apparatus 10 inputs, by operating the pointing device or keyboard of the operation device 12, the instruction for cancelling the detail of the next reservation for the meeting room II in the timetable of meeting 41, and the instruction to reserve the other meeting room. In this case, the controller 19 rewrites the timetable of meeting 41 stored in the storage device 17 according to the mentioned instructions, thus to update the timetable of meeting 41. The timetable of meeting 41 updated as above is shared among the information processing apparatuses 10, by means of synchronization. In the case where those instructions are not inputted to the operation device 12, the controller 19 keeps the current content of the timetable of meeting 41 unchanged, without cancelling the detail of the next reservation for the meeting room II.

The controller 19 of the information processing apparatus 10 of the meeting room causes the display device 11 to display, when the communication device 14 receives the updated timetable of meeting 41, the updated timetable of meeting 41 on the screen. In view of the updated timetable of meeting 41 displayed on the screen of the display device 11, the manager is made aware that the detail of the next reservation for the meeting room II has been cancelled, and extends the meeting by changing the end time in the detail of the reservation for the meeting room II, through the pointing device or keyboard of the operation device 12, thus further updating the timetable of meeting 41 (step S135). The timetable of meeting 41 updated as above is shared among the information processing apparatuses 10, by means of synchronization.

In the case where the detail of the next reservation for the meeting room II has not been changed, the manager recognizes that the detail of the next reservation for the meeting room II has not been changed, in view of the timetable of meeting 41 displayed on the screen of the display device 11.

Further, the controller 19 of the information processing apparatus 10 of the meeting room erases the pop-up window PU5 from the screen of the display device 11, when a predetermined time has elapsed after the pop-up window PU5 started to be displayed.

As described thus far, with the configuration according to the foregoing embodiment, even though the input of the exit notification with respect to the meeting room is forgotten, the use status of the meeting room in the timetable of meeting 41 is changed from “occupied” to “vacant”, provided that any one of the users participating in the meeting in the meeting room logs out from the information processing apparatus 10. Further, the request from the participant to cancel the reservation for the meeting room, and the request from the manager to extend the use of the meeting room, can be properly processed in accordance with the use status of the meeting room in the timetable of meeting 41, and therefore the utilization efficiency of the meeting room can be improved.

The present invention may be modified in various manners, without limitation to the configuration according to the foregoing embodiment. Further, the configurations and processings according to the foregoing embodiment and the variations thereof, described with reference to FIG. 1 to FIG. 15, are merely exemplary, and in no way intended to limit the disclosure to those configurations and processings.

1. An information processing apparatus that shares a timetable containing information indicating at least one of a state of “reserved”, a state of “occupied”, and a state of “vacant”, with respect to an event execution site, and a manager who has made reservation for the event execution site, with another information processing apparatus via a server on a network, the information processing apparatus comprising:
a communication device that transmits and receives data including the timetable, to and from the other information processing apparatus via the server;
a storage device for storing the timetable;
a display device;
an operation device to which an instruction based on user's operation is inputted; and
a controller that includes a processor and, through the processor executing a control program:
writes the “reserved” and the manager in the timetable, when the reservation for the event execution site and the manager are inputted to the operation device;
writes the “occupied” in the timetable, when entry to the reserved event execution site is inputted to the operation device; and
updates the timetable by substituting the “occupied” of the event execution site with the “vacant”, and causes the display device to display the timetable, when the communication device receives information that the manager has logged out from the other information processing apparatus, and a predetermined time has elapsed after a time of the log-out, in a state where exit from the occupied event execution site has not been inputted to the operation device.

2. The information processing apparatus according to claim 1,
wherein the controller is configured to:
write that the event execution site is waiting for entry in the timetable, with respect to the event execution site, the use start time of which has been reached, and the entry to which has not been inputted to the operation device; and
cause the display device to display, when the communication device receives a reservation cancel request with respect to the event execution site that is waiting for entry, from the other information processing apparatus via the network, a message asking whether to approve the cancel request, cancel the reservation for the event execution site specified as waiting for entry in the timetable, when approval for the cancel request is inputted to the operation device, and writes the reservation for the event execution site made by the other information processing apparatus, in the timetable.

3. The information processing apparatus according to claim 1,
wherein the controller is configured to:
cause the display device to display a message asking whether to request extension of use of the event execution site, when the event execution site is specified as occupied, and a next reservation for the event execution site is written in the timetable;
transmit, when the request for extension of use is inputted to the operation device, the request for extension of use of the event execution site, to the other information processing apparatus that made the next reservation for the event execution site, from the communication device via the network; and
extend, when the communication device receives approval for the extension of use of the event execution site, from the other information processing apparatus via the network, a reservation period of the event execution site specified as occupied, in the timetable.

4. The information processing apparatus according to claim 3,
wherein the controller extends the reservation period, by deleting the next reservation in the timetable, when the communication device receives the approval for the extension of use.

5. The information processing apparatus according to claim 1,
wherein the controller causes the display device to display a message urging to make reservation for another event execution site, when the event execution site is specified as occupied in the timetable, and a period of use of the event execution site is about to end, and writes the reservation for the other event execution site in the timetable, when a request for the reservation for the other event execution site is inputted to the operation device.

6. The information processing apparatus according to claim 1,
wherein the controller is configured to:
cause the display device to display a next reservation for the event execution site, and a message indicating whether to request to change the next reservation to reservation for another event execution site, when the event execution site is specified as occupied in the timetable, and a period of use of the event execution site is about to end; and
transmit, when the request to change the reservation is inputted to the operation device, the request to change the reservation to the other information processing apparatus that made the next reservation for the event execution site, from the communication device via the network.

7. The information processing apparatus according to claim 1,
wherein the controller writes, in a case where information indicating a state of “temporary exit” of the event execution site is inputted to the operation device, when the event execution site is specified as occupied in the timetable, the state of “temporary exit” with respect to the event execution site in the timetable, and maintains the occupied state of the event execution site, irrespective of whether the communication device has received the log-out information of the manager from the other information processing apparatus.

8. A reservation management system comprising a plurality of information processing apparatuses that share, with one another, a timetable containing information indicating at least one of reservation, an occupied state, and a vacant state with respect to an event execution site, and a manager who has made the reservation for the event execution site, via a server on a network,
wherein at least one of the plurality of information processing apparatuses is the information processing apparatus according to claim 1.
